(19) United States
(12) Patent Application Publication
(10) Pub. No.: US 2026/0336649 A1
(43) Pub. Date: Oct. 29, 2026

(54) SYSTEMS AND METHODS FOR AUTOMATED DRIVER BEHAVIOR ANALYSIS AND ADAPTIVE FEEDBACK

(71) Applicant: MOTIVE TECHNOLOGIES, INC., San Francisco, CA (US)

(72) Inventors: Farhan ALI, San Francisco, CA (US); Chandramouly RATHINASABABATHY, Fremont, CA (US)

(73) Assignee: MOTIVE TECHNOLOGIES, INC., San Francisco, CA (US)

(21) Appl. No.: 19/443,484

(22) Filed: Jan. 8, 2026

Related U.S. Application Data
(60) Provisional application No. 63/795,042, filed on Apr. 25, 2025.

(51) Int. Cl. B60W 50/14; B60W 40/09

(52) U.S. Cl. CPC B60W 50/14; B60W 40/09; B60W 2050/146; B60W 2556/10; B60W 2556/45

(57) ABSTRACT

The techniques described herein relate to a system including: a vehicle gateway device configured to receive driver behavior data and transmit the driver behavior data; and a remote computing system configured to: receive, from the vehicle gateway device, the driver behavior data; analyze the driver behavior to identify a safety-related event; determine a safety metric based on the identified safety-related event; generate, via a first artificial intelligence model, a feedback script based on the identified safety-related event and the determined safety metric; perform, via a second artificial intelligence model, a quality assurance check on the feedback script to identify a deficiency; update, via the first artificial intelligence model, the feedback script based on the identified deficiency; generate a feedback video based on the updated feedback script; and transmit the feedback video to a device associated with a driver of the vehicle.

### CROSS REFERENCE TO RELATED APPLICATIONS

This application claims the benefit of and priority from U.S. Provisional Application No. 63/795,042, filed Apr. 25, 2025, whereby the contents of which are incorporated by reference in its entirety.

### BACKGROUND

Modern commercial fleets generate extensive sensor data—such as vehicle speed, acceleration, braking patterns, and in-cab camera feeds (e.g., forward-facing and/or cabin-facing cameras)—to support driver safety and risk management. However, existing solutions concentrate primarily on collecting and reporting this information and continue to rely on manual analysis and human-led coaching. As a result, feedback quality varies, intervention is postponed, and scalability across large driver populations remains restricted.

### BRIEF DESCRIPTION OF THE FIGURES

FIG. 1 is a block diagram illustrating a driver feedback system according to some of the disclosed embodiments.

FIG. 2 is a flow diagram illustrating a method for automatically generating a script based on multi-modal data according to some of the disclosed embodiments.

FIG. 3 is a flow diagram illustrating a method for automatically generating a pedagogically structured, multi-scene video based on a validated script according to some of the disclosed embodiments.

FIG. 4 is a flow diagram illustrating a method for performing a control operation to implement a coaching recommendation according to some of the disclosed embodiments.

FIG. 5 is a flow diagram illustrating a method for automatically updating and refining script and video generation models according to some of the disclosed embodiments.

FIG. 6 is a block diagram of a computing device according to some embodiments of the disclosure.

### DETAILED DESCRIPTION

Current systems for driver safety and coaching are primarily focused on the collection and reporting of sensor data, such as telematics metrics and camera feeds, and rely heavily on manual review and human-led coaching interventions. This dependence on human analysis introduces significant variability in feedback quality, delays in intervention, and limits the scalability of safety programs across large and diverse driver populations.

In practice, fleet safety managers are often overwhelmed by the sheer volume and complexity of data generated by modern vehicles. The process of manually reviewing events, identifying patterns, and delivering timely, personalized coaching is both resource-intensive and inconsistent. As a result, many unsafe driving behaviors go unaddressed, opportunities for positive reinforcement are missed, and the overall effectiveness of safety initiatives is diminished. Furthermore, existing systems lack the ability to provide standardized, data-driven, and automated feedback at scale, making it difficult for organizations to ensure uniform safety standards and continuous improvement across their fleets.

The disclosed systems and methods address these technical challenges, among others, through an autonomous driver feedback system. The system is designed to provide an end-to-end, fully autonomous solution for driver behavior analysis, feedback generation through automated generation of personalized coaching videos, and continuous improvement. By integrating multi-modal data sources—including telematics sensors, cabin-facing and environment-facing cameras, and historical coaching records—the system creates a comprehensive and context-rich profile of each driver’s performance. Advanced deterministic processing modules extract and classify safety-related events—including unsafe or positive behaviors—while derived safety metrics such as driver safety scores, performance trends, and performance volatility are calculated to provide a holistic view of driver risk and improvement opportunities.

The system includes an automated script generation engine, which transforms structured, pre-processed data—such as the driver safety scores and the classified driving behaviors—into individualized, factually grounded feedback scripts. In some implementations, these scripts are generated using a large language model (LLM) that is guided by explicit instructions, organizational policies, and historical coaching context. By utilizing deterministic processes and specialized modules, such as computer vision modules, to generate structured input data for the LLM, the system reduces the risk of the LLM hallucinating or introducing other errors when generating the script. In some implementations, the LLM can be provided with structured data as input that instructs the LLM to generate the script according to a defined multi-scene structure. This may, for example, assist the system in parsing the script for automated video generation downstream. The LLM may also be prompted to perform an internal planning phase, to generate the script with a natural flow, to provide certain approved recommendations to the driver, and/or the like, ensuring that the resulting narrative is logically organized, pedagogically effective, and tailored to the driver’s unique behavioral profile.

Once generated, the system may subject the script to a rigorous, multi-dimensional quality assurance (QA) process, verifying the script across dimensions such as factuality, relevancy, naturalness, and tonality before being validated for downstream use. To ensure the quality of outputted scripts, the system may utilize an artificial intelligence (AI) judge, such as a specifically prompted LLM judge, for each dimension. In some implementations, if the script fails the QA process for any dimension, an appropriate AI judge generates feedback detailing the identified fault, and provides the feedback to the script generation engine to re-generate the script. In some implementations, this loop may continue until the script passes all QA checks and is thus validated.

Once validated, the script serves as the foundation for an automatically generated, multi-scene, avatar-led feedback video. In some implementations, the system utilizes a video generation engine to ingest and parse the validated script. The system may select an appropriate avatar for narration from a library or may generate a new custom avatar based on an organization’s safety manager or some other trusted figure, for example. In some implementations, the system programmatically assembles pre-rendered assets and dynamically generated segments, synchronizing the avatar’s narration with supporting media such as dashcam footage of an instance of unsafe behavior, map images to illustrate speed locations, data visualizations, or the like. This approach delivers a highly engaging and personalized feedback experience, enabling drivers to visualize specific events and understand the context behind each coaching recommendation.

In some implementations, the system features a closed-loop architecture that further enables continuous learning and improvement. For example, the system may track coaching effectiveness and determine correlations between coaching characteristics and behavioral outcomes. Based on these determinations, the system may, for example, iteratively refine prompting strategies and QA rubrics, thereby adapting over time to maximize its impact on driver safety and fleet risk reduction. The result is a scalable, standardized, and data-driven platform that delivers timely, actionable, and consistent feedback across large and diverse driver populations, supporting sustained behavioral change and organizational safety objectives.

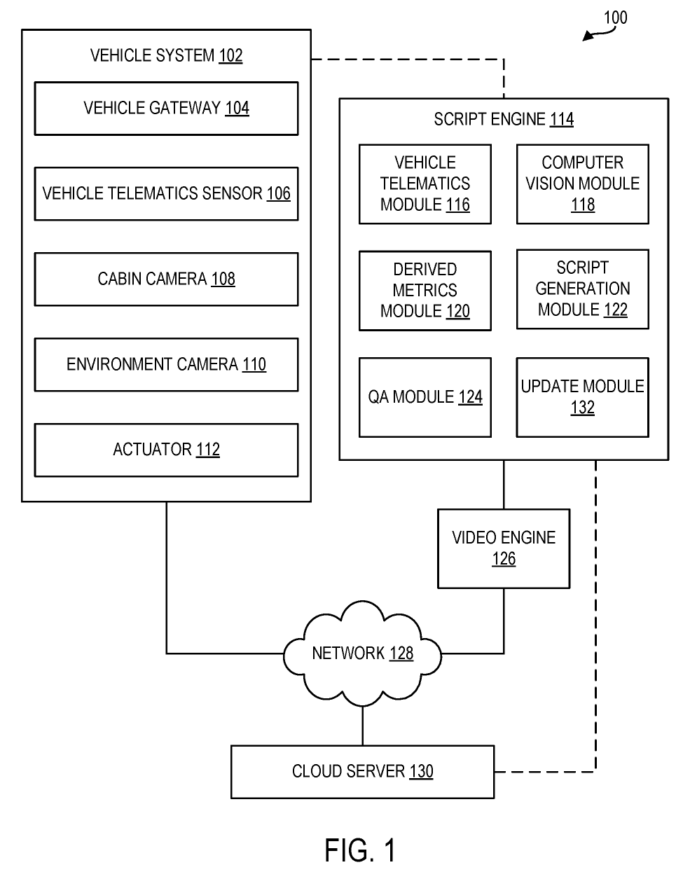

FIG. 1 is a block diagram illustrating a driver feedback system according to some of the disclosed embodiments.

In the illustrated embodiment, the system 100 includes a vehicle system 102 that interfaces with a cloud server 130 via a network 128. As illustrated, the vehicle system 102 includes a vehicle gateway 104, a vehicle telematics sensor 106, a cabin camera 108, an environment camera 110, and an actuator 112. In some implementations, the vehicle system 102 further comprises a vehicle, with the vehicle gateway 104, the vehicle telematics sensor 106, the cabin camera 108, the environment camera 110, and/or the actuator 112 being integrated with the vehicle. Alternatively, in some implementations, the vehicle system 102 comprises the vehicle gateway 104, the vehicle telematics sensor 106, the cabin camera 108, the environment camera 110, and/or the actuator 112, with the vehicle gateway 104, the vehicle telematics sensor 106, the cabin camera 108, and/or the environment camera 110 being separate from the vehicle and configured to interface with and/or to gather information associated with the vehicle and/or a driver of the vehicle.

The vehicle can be any type of vehicle, such as, but not limited to, an electric vehicle, a hybrid electric vehicle, an internal combustion vehicle, a car, a truck, a pickup truck, a semi-truck, or any other type of vehicle. In some implementations, the vehicle includes various systems and electronic control units (ECUs) to control operations of the vehicle, such as, but not limited to, a transmission control module (TCM), a telematics control unit (TCU), a throttle actuator control (TAC), a brake system control unit (e.g., an anti-lock braking system (ABS) , an electronic stability control (ESC) module), a motor control unit (MCU), an engine control unit, a battery management system (BMS), a vehicle control unit (VCU), a powertrain control module (PCM), an electric power steering ECU, advanced driver assistance systems (ADAS), an autonomous driving control unit (ADCU), a sensor fusion ECU, and/or the like.

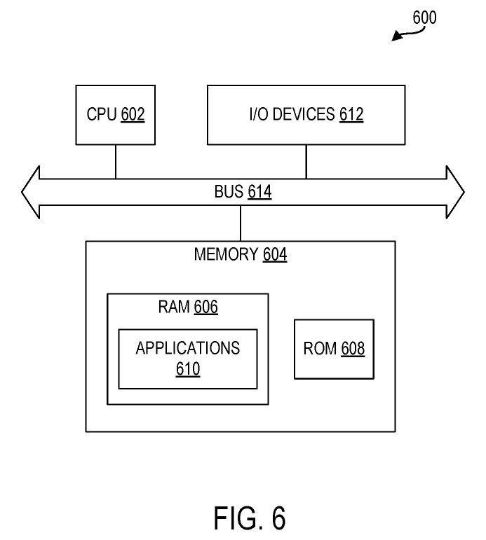

In some implementations, the vehicle gateway 104 can be configured to be positioned in a cabin of the vehicle and/or to interface with the vehicle via a wired connection (e.g., by being plugged into an OBD-II port or the like) and/or a wireless connection (e.g., Bluetooth®, Wi-Fi, or the like). In some implementations, the vehicle gateway 104 comprises an electronic control unit(s) of the vehicle (e.g., the TCU) and/or a computing device (e.g., as described in relation to FIG. 6) that operates via power received from the vehicle and/or via a battery of the vehicle gateway 104 (e.g., such as in implementations where the vehicle gateway 104 is a mobile and/or separate device from the vehicle). The vehicle gateway 104 can serve as a communication hub for vehicle-based sensors and devices (e.g., sensors and/or devices integrated with or located on/within the vehicle). For example, in some implementations, the vehicle gateway 104 comprises an edge device configured to communicate with the cloud server 130 via the network 128. In some implementations, the vehicle gateway 104 can access edge computing resources (e.g., controllers and/or ECU(s) of the vehicle and/or the vehicle gateway 104’s own computing resources), near-edge computing resources (e.g., via network 128), and/or cloud-based resources (e.g., cloud server 130) to process and/or preprocess data thereby enabling the vehicle gateway 104 and/or the vehicle to perform complex computations (e.g., computer vision, autonomous driving, and the like) in real time.

The vehicle gateway 104 is communicatively coupled (e.g., via a wired and/or wireless connection) to the vehicle telematics sensor 106, the cabin camera 108, the environment camera 110, and the actuator 112. In some implementations, the vehicle gateway 104 is configured to receive vehicle telematics data from the vehicle telematics sensor 106, driver image data (which may also be referred to as driver-associated image data) from the cabin camera 108, and/or environment image data (which may also be referred to as environment-associated image data) from the environment camera 110. In some implementations, the vehicle gateway 104 is further configured to transmit the vehicle telematics data, the driver image data, and/or the environment image data to the cloud server 130 via the network 128. In some implementations, the vehicle gateway 104 can control (and/or relay commands that cause the control of) operations of the vehicle (e.g., steering, braking, acceleration, top speed, and the like) by interfacing with components and/or systems of the vehicle (e.g., the actuator 112, ADCU, ADAS, VCU, and the like) via a network of the vehicle (e.g., a controller area network (CAN) bus, FlexRay, ethernet, local interconnect network (LIN) bus, and the like) and an interface (e.g., OBD-II or other type of diagnostic port, a TCU or other connectivity gateway, and the like).

The vehicle telematics sensor 106 provides continuous and/or periodic monitoring of operational parameters of the vehicle to generate the vehicle telematics data. The vehicle telematics data can include, but is not limited to, vehicle position information (e.g., latitude and longitude coordinates of the vehicle, a bearing angle of the vehicle, and the like), vehicle speed, longitudinal and lateral acceleration/deceleration, yaw rate, steering angle, brake pedal position, accelerator pedal position, and/or the like.

In some implementations, the vehicle telematics sensor 106 can comprise any one or combination of a GNSS receiver(s) (e.g., GPS, GLONASS, Galileo, or the like), a wheel speed sensor(s), a gyroscope or yaw rate sensor(s), an accelerometer(s), a steering angle sensor(s), an inertial measurement unit (IMU), a brake pedal position sensor(s), an accelerator pedal position sensor(s), and/or the like. In some implementations, the vehicle telematics sensor 106 can be integrated with the vehicle and/or with the vehicle gateway 104 (and/or with a peripheral device(s) positioned on or within the vehicle, such as a mobile device associated with the driver).

As discussed further below, in some implementations, the vehicle telematics data can indicate/include indicators of unsafe/negative behaviors and/or safe/positive behaviors. For example, in some implementations, unsafe/negative behaviors that can be indicated by the vehicle telematics data or derived based on the vehicle telematics data can include, but are not limited to, a seatbelt violation, speeding, hard braking, hard acceleration, hard corning, and/or the like. In some implementations, safe/positive behaviors that can be indicated by the vehicle telematics data or derived based on the vehicle telematics data can include, but are not limited to, seatbelt usage, driving within the speed limit, moderate or controlled braking, moderate or controlled acceleration, moderate or controlled corning, and/or the like.

The cabin camera 108 provides continuous and/or periodic monitoring of the interior of the vehicle to generate the driver image data. The driver image data can comprise an image(s) or a sequence of images (e.g., video) of the driver. In some implementations, the cabin camera 108 comprises one or more cameras that are integrated with the vehicle’s interior and/or that are integrated with (or communicatively coupled to) the vehicle gateway 104 (e.g., as a driver-facing dashcam). In some implementations, the cabin camera 108 may also be equipped with infrared or other low-light capabilities to ensure reliable monitoring under varying lighting conditions.

As discussed further below, in some implementations, the driver image data can indicate/include indicators of unsafe/negative behaviors and/or safe/positive behaviors. For example, in some implementations, unsafe/negative behaviors that can be indicated by the driver image data or derived based on the driver image data can include, but are not limited to, driving without two hands on the steering wheel, phone/device usage, eating, distraction, and/or the like. In some implementations, safe/positive behaviors that can be indicated by the driver image data or derived based on the driver image data can include, but are not limited to, driving with both hands on the steering wheel, no phone/device usage, alert driving, and/or the like.

The environment camera 110 provides continuous and/or periodic monitoring of the external surroundings of the vehicle to generate the environment image data. The environment image data can comprise an image(s) or a sequence of images (e.g., video) of the surrounding environment of the vehicle (e.g., the road/lane(s) positioned ahead, behind, and/or to a side of the vehicle). In some implementations, the environment camera 110 comprises one or more cameras that are mounted on the exterior of the vehicle (e.g., on a windshield, bumper, mirror, fender, or the like) and/or that are integrated with (or communicatively coupled to) the vehicle gateway 104 (e.g., as a road-facing dashcam that is separate from or combined with the cabin camera 108). In some implementations, the environment camera 110 may be or may further include a LiDAR sensor(s), a radar sensor(s), an ultrasonic sensor(s), and/or the like to generate or supplement the environment image data (e.g., such that the environment image data comprises image/video, LiDAR, radar, and/or ultrasonic data).

As discussed further below, in some implementations, the environment image data can indicate/include indicators of unsafe/negative behaviors and/or safe/positive behaviors. For example, in some implementations, unsafe/negative behaviors that can be indicated by the environment image data or derived based on the environment image data can include, but are not limited to, insufficient following distance / tailgating, stop sign violations, and/or the like. In some implementations, safe/positive behaviors that can be indicated by the environment image data or derived based on the environment image data can include, but are not limited to, sufficient following distance, no stop sign violations, and/or the like.

The actuator 112 may comprise any type of actuator, such as, but not limited to, an electric motor, a haptic feedback generator (e.g., a haptic or vibration actuator, or the like), a speaker, a throttle actuator, a fuel injector, brakes, a steering actuator, and/or any other type of vehicle actuator. In some implementations, the actuator 112 comprises a plurality of actuators. In some implementations, the actuator 112 is integrated with and/or coupled to the vehicle. As an example, in some implementations, the actuator 112 comprises a haptic feedback generator that is coupled to and/or positioned within a steering wheel and/or a seat of the vehicle. As another example, in some implementations, the actuator 112 comprises a steering actuator(s) configured to control steering of the vehicle and/or a brake actuator(s) configured to control braking of the vehicle (e.g., to enable autonomous control of the vehicle).

The cloud server 130 may be any type of remote or cloud operating platform and/or network-based system upon which applications, operations, and/or other forms of network resources may be located. For example, the cloud server 130 may be a service provider and/or network provider from where services and/or applications may be accessed, sourced or executed. For example, the cloud server 130 can represent the cloud-based architecture associated with a service provider, content provider, internet service provider (ISP), communication service provider (CSP), and the like, which has associated network resources hosted on the internet or private network (e.g., network 128). In some implementations, the cloud server 130 may include a server(s), a distributed server, and/or a database(s) of information which is accessible over the network 128. For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server.

The network 128 may be any type of network, such as, but not limited to, a wireless network, a cellular network, a vehicle-to-network (V2N), a vehicle-to-everything (V2X), a dedicated short-range communications (DSRC), the internet, and/or combinations thereof. In some implementations, the network 128 facilitates connectivity of the components of the system 100 (e.g., as illustrated in FIG. 1).

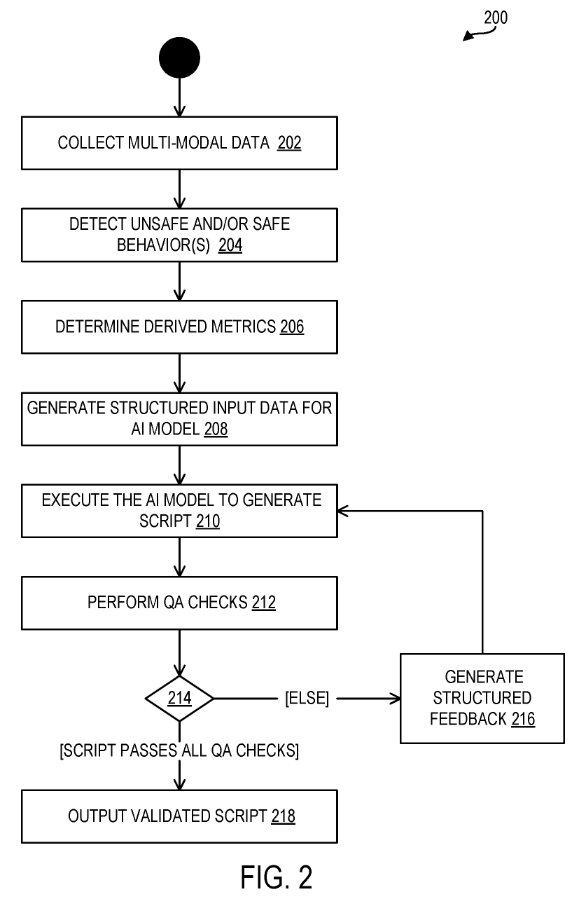

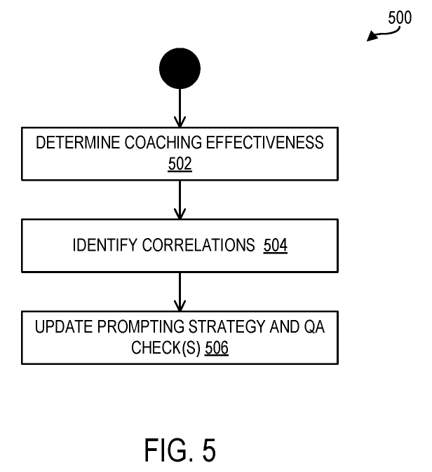

As illustrated in FIG. 1, the system 100 can include a script engine 114 for transforming multi-modal data into factually grounded, individualized feedback scripts for drivers. In some implementations, the script engine 114 is hosted on or implemented in the cloud server 130 and/or another computing device connected to the network 128, and/or can receive the vehicle telematics data, the driver image data, and/or the environment image data from the vehicle gateway 104 (e.g., via the network 128). In addition or alternatively, in some implementations, the script engine 114 is hosted on or implemented in the vehicle gateway 104 and/or another component of the vehicle system 102 and/or vehicle. In some implementations, the script engine 114 includes a vehicle telematics module 116, a computer vision module 118, a derived metrics module 120, a script generation module 122, a QA module 124, and/or an update module 132. More detail of the operations, configurations and functionalities of the script engine 114 and each of its modules, and their role within implementations of the present disclosure will be discussed below (e.g., with regard to FIGS. 2 and 5).

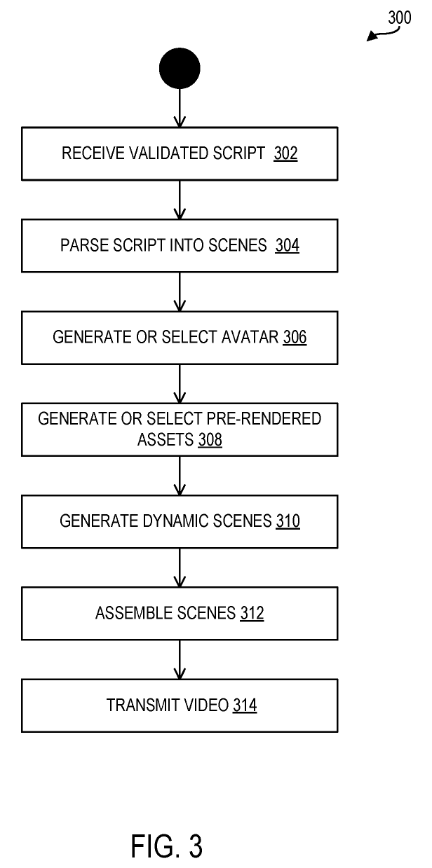

As illustrated in FIG. 1, the system 100 can include a video engine 126 (which may also be referred to as a video generation engine) for automatically generating a pedagogically structured, multi-scene video based on a validated script. In some implementations, the video engine 126 is hosted on or implemented in the cloud server 130 and/or another computing device connected to the network 128, and/or can receive a validated script from the script engine 114. In addition or alternatively, in some implementations, the video engine 126 is hosted on or implemented in the vehicle gateway 104 and/or another component of the vehicle system 102 and/or vehicle. More detail of the operations, configurations and functionalities of the video engine 126, and its role within implementations of the present disclosure will be discussed below (e.g., with regard to FIG. 3).

It should be understood that the engine(s) and modules discussed herein are non-exhaustive, as additional or fewer engines and/or modules (or sub-modules) may be applicable to the implementation of the systems and methods discussed herein.

Through this architecture, as described herein, the system 100 delivers a comprehensive technical solution for automated, scalable, and personalized driver behavior analysis and feedback. By combining vehicle-based sensors—including telematics sensors, and cabin and/or environment cameras—the system 100 establishes a robust platform for the monitoring, detection, and contextual evaluation of both unsafe and safe driving behaviors. As discussed further below, the system 100’s closed-loop design enables end-to-end automation of data ingestion, individualized script and video feedback generation, and iterative improvement, ensuring consistent, timely, and effective behavioral modification across large fleets without reliance on manual intervention.

FIG. 2 is a flow diagram illustrating a method for automatically generating a script based on multi-modal data. In some implementations, method 200 may be performed by the script engine 114 of FIG. 1. For example, in some implementations, steps 202 and 204 can be performed by the vehicle telematics module 116 and computer vision module 118 of the script engine 114; step 206 can be performed by the derived metrics module 120; steps 208 and 210 can be performed by the script generation module 122; and steps 212, 214, 216, and 218 can be performed by the QA module 124.

Referring to FIG. 2, in step 202, the method 200 includes collecting multi-modal data (which may also be referred to as driver behavior data) from a vehicle.

In some implementations, the multi-modal data may include, but is not limited to, vehicle telematics data (which, e.g., may be captured via the vehicle telematics sensor 106); driver image data (which, e.g., may be captured via the cabin camera 108); and/or environment image data (which, e.g., may be captured via the environment camera 110).

In some implementations, the multi-modal data may be collected continuously and/or periodically (e.g., every minute, hour, day, week, or the like). As an example, in some implementations, the multi-modal data may be transmitted (e.g., to cloud server 130) via a vehicle gateway device of the vehicle (e.g., vehicle gateway 104) such that the multi-modal data is collected/received in real-time or in batches (e.g., representing sensor data for specific periods of time).

In step 204, the method 200 detects one or more unsafe and/or safe driving behaviors (which may also be referred to as safety-related events) based on the multi-modal data. Although the description describes safety-related events, the disclosure is not limited as such and the systems and methods may other types of events including, but not limited to, compliance events, fuel-related events, and generally any type of event generated during the operation of a vehicle.

For example, in some implementations, the method 200 may detect unsafe and/or safe driving behaviors based on the vehicle telematics data. As discussed herein, in some implementations, unsafe/negative behaviors that can be indicated by the vehicle telematics data or derived based on the vehicle telematics data can include, but are not limited to, a seatbelt violation, speeding, hard braking, hard acceleration, hard corning, and/or the like. In some implementations, safe/positive behaviors that can be indicated by the vehicle telematics data or derived based on the vehicle telematics data can include, but are not limited to, seatbelt usage, driving within the speed limit, moderate or controlled braking, moderate or controlled acceleration, moderate or controlled corning, and/or the like.

As an example, in some implementations, the method 200 detects a seatbelt violation based on the vehicle telematics data received from the vehicle. In some implementations, the vehicle telematics data includes status signals from a seatbelt sensor (e.g., vehicle telematics sensor 106). The seatbelt status signals may indicate whether the driver’s seatbelt is fastened or unfastened during vehicle operation. In some implementations, the method 200 monitors the seatbelt status signal along with other telematics parameters included in the vehicle telematics data, such as vehicle speed and/or ignition status. In some implementations, the method 200 detects/identifies a seatbelt violation when the vehicle telematics data indicates that the vehicle is in motion—determined, for example, by a speed value greater than a threshold—while the seatbelt sensor signal reflects an unfastened state. Upon detection of this condition, the method 200 may record a seatbelt violation event, optionally capturing relevant contextual information such as the time, location, and/or duration of the seatbelt violation event, and/or an image of the driver for further analysis, feedback, or trouble shooting.

Conversely, in some implementations, the method 200 may detect positive seatbelt usage when the vehicle telematics data indicates the vehicle is in motion while the seatbelt sensor signal reflects a fastened state. In some implementations, the method 200 infers safe/positive seatbelt behavior based on an absence of seatbelt violation events.

In addition or alternatively, in some implementations, the method 200 detects speeding based on the vehicle telematics data received from the vehicle. In some implementations, the method 200 may compare a vehicle’s speed (e.g., as indicated in the vehicle telematics data) to an applicable speed limit for the vehicle’s location. In some implementations, the vehicle telematics data can include the vehicle’s location for each reported speed. In some implementations, the applicable speed limit may be determined by referencing a geospatial database of posted speed limits and/or the like. In addition or alternatively, in some implementations, the applicable speed limit may be included in the vehicle telematics data. For example, in some implementations, the environment camera 110 may determine the applicable speed limit using computer vision to read speed limit signs, a navigation system of the vehicle may determine the speed limit, and/or the like. In some implementations, the method 200 detects/identifies a speeding event when the vehicle’s speed exceeds a corresponding speed limit by a predefined threshold (which, e.g., may account for minor fluctuations or measurement tolerances). Upon identifying such an event, in some implementations, the method 200 records the speeding event, optionally capturing relevant contextual information such as the time, location, duration, and/or magnitude of the speeding event.

Conversely, in some implementations, the method 200 may detect driving within the speed limit when the vehicle telematics data indicates the vehicle’s speed does not exceed the applicable speed limit by the predefined threshold. In some implementations, the method 200 infers safe/positive speed behavior based on an absence of speeding events.

In addition or alternatively, in some implementations, the method 200 may detect hard braking, hard acceleration, and/or hard corning based on the vehicle telematics data received from the vehicle. As an example, in some implementations, the method 200 may identify hard braking and/or hard acceleration based on longitudinal acceleration values that may be included in the vehicle telematics data and/or may identify hard corning based on lateral acceleration values that may be included in the vehicle telematics data. In some implementations, the method 200 may detect unsafe/safe driver behaviors based on the vehicle telematics data in real time or through post-processing. In some implementations, the method 200 may identify negative longitudinal acceleration values that are less than a predefined threshold (e.g., -0.5 g-force) as a hard braking event. Similarly, in some implementations, the method 200 may identify positive longitudinal acceleration values that are greater than a predefined threshold (e.g., 0.3 g-force) as a hard acceleration event. In some implementations, the method 200 may identify lateral acceleration values that are greater than a predefined threshold (e.g., 0.5 g-force) as a hard cornering event. Upon identifying such a hard braking event, a hard acceleration event, and/or a hard corning event, in some implementations, the method 200 records the event, optionally capturing relevant contextual information such as the time, location, duration, and/or magnitude of the hard braking event, the hard acceleration event, and/or the hard cornering event.

Conversely, in some implementations, the method 200 may detect moderate or controlled braking, moderate or controlled acceleration, and/or moderate or controlled corning when the vehicle telematics data indicates the vehicle’s longitudinal acceleration and/or lateral acceleration does not exceed or fall below applicable predefined thresholds. In some implementations, the method 200 infers safe/positive braking, acceleration, and/or cornering behavior based on an absence of hard braking, acceleration, and/or cornering events.

In some implementations, detecting hard braking, accelerating, and/or cornering events is based on baselines or expected values associated with specific segments of roadways. For example, in some implementations, the method 200 may continuously or periodically collect vehicle telematics data from multiple vehicles and aggregate the data across multiple drivers for respective road segments to establish the baseline or expected values for each metric. For example, in some implementations, the method 200 may calculate the average hard braking, acceleration, and/or corning values for a particular road segment by aggregating data from multiple drivers who have traversed that segment and then determine respective thresholds based on the average. This process can ensure that the baseline reflects typical driving conditions and behaviors for each road segment, accounting for factors such as road geometry, traffic patterns, and environmental influences. In some implementations, the method 200 may incorporate contextual information such as environmental conditions, video or image data, vehicle class, and/or the like to enable a more granular and context-aware determination of baseline or expected values.

In addition or alternatively, in some implementations, the method 200 may detect unsafe and/or safe driving behaviors based on the driver image data. As discussed herein, in some implementations, unsafe/negative behaviors that can be indicated by the driver image data or derived based on the driver image data can include, but are not limited to, driving without two hands on the steering wheel, phone/device usage, eating, distraction, and/or the like. In some implementations, safe/positive behaviors that can be indicated by the driver image data or derived based on the driver image data can include, but are not limited to, driving with both hands on the steering wheel, no phone/device usage, alert driving, and/or the like.

As discussed above, in some implementations, the driver image data can be captured via one or more driver-facing cameras (e.g., cabin camera 108) and can comprise images or video of the driver during vehicle operation. In some implementations, the method 200 may detect unsafe/safe driver behaviors based on the driver image data in real time or through post-processing. In some implementations, the method 200 may employ a computer vision system/model (e.g., computer vision module 118) to analyze the driver’s behavior and detect unsafe/safe behaviors. The computer vision system may include, but is not limited to, a convolutional neural network(s) (CNN(s)), a deep learning model(s), an object detection model(s), a pose and/or landmark estimation model(s), a gaze and eye tracking model(s), a temporal/sequential model(s), a multi-modal fusion model (combing, e.g., image/video, infrared data, CAN data, and/or the like), and/or the like.

As an example, in some implementations, the method 200 may detect instances of driving without two hands on the steering wheel by analyzing the driver image data using the computer vision system. For example, in some implementations, the computer vision system may analyze the position and/or orientation of the driver’s hands relative to the steering wheel (e.g., by leveraging hand key point detection, steering wheel detection, upper-body landmark recognition, and/or the like). If the computer vision system determines that one or both hands are not in contact with the steering wheel for a predefined time period and/or while the vehicle’s speed is above a predefined threshold, the method 200 records a steering wheel violation event. In some implementations, the method 200 may not consider one hand on the steering wheel a steering wheel violation event such that one-handed driving is allowed (in some implementations, whether one or two hands is required may be based on vehicle speed, driving conditions (e.g., rain, snow), or the like). In some implementations, the method 200 infers safe/positive steering wheel control behavior based on an absence of steering wheel violation events.

As another example, in some implementations, the method 200 may detect phone/device usage and/or eating by analyzing the driver image data using the computer vision system. For example, in some implementations, the computer vision system is trained to identify the presence of a phone (or other device) and/or common food items (e.g., a burrito, a burger, or the like) in the driver’s hands and/or near the driver’s face. In addition or alternatively, in some implementations, the computer vision model is trained to identify hand movements, face/mouth movements, and/or gaze patterns that are associated with device usage or eating. In some implementations, when the method 200 detects that the driver was/is holding, viewing, and/or interacting with a phone/device and/or eating (e.g., while the vehicle is in motion or the like), the method 200 records a device usage event or an eating event, optionally recording and associating the event with supporting image/video evidence and/or relevant context such as the time, location, and/or duration of the device usage event or eating event. In some implementations, the method 200 infers safe/positive behavior based on an absence of phone/device usage or eating events.

As yet another example, in some implementations, the method 200 may detect distraction by analyzing the driver image data using the computer vision system. For example, in some implementations, the computer vision system analyzes the driver’s head pose, eye movement, gaze direction, and/or facial expressions to assess attentiveness. Indicators of distraction may include, but are not limited to, frequent glances away from the road, prolonged periods of looking away from the road, engagement in secondary activities such as talking to passengers, and/or the like. In some implementations, when distraction is detected, the method 200 records a distraction event, optionally recording and associating the distraction event with supporting image/video evidence and/or relevant context such as the time, location, and/or duration of the distraction event. In some implementations, the method 200 infers safe/positive alert behavior based on an absence of distraction events.

In addition or alternatively, in some implementations, the method 200 may detect unsafe and/or safe driving behaviors based on the environment image data. As discussed herein, in some implementations, unsafe/negative behaviors that can be indicated by the environment image data or derived based on the environment image data can include, but are not limited to, insufficient following distance / tailgating, stop sign violations, and/or the like.

As discussed above, in some implementations, the environment image data can be captured via one or more outward-facing cameras (e.g., environment camera 110) and can comprise images/video of the roadway and surrounding environment during vehicle operation (and including, in some implementations, radar, LiDAR, or ultrasonic data). In some implementations, the method 200 may detect unsafe/safe driving behaviors based on the environment image data in real time or through post-processing. In some implementations, the method 200 may employ a computer vision system/model (e.g., computer vision module 118) to analyze the environment image data and detect behaviors such as tailgating and stop sign violations. The computer vision system may include, but is not limited to, a CNN(s), a deep learning model(s), an object detection model(s), a distance estimation model(s), a lane detection model(s), a temporal or sequential model(s), a multi-modal fusion model(s) (e.g., that combines image/video, telematics, and/or other sensor data), and/or the like.

As an example, in some implementations, the method 200 may detect instances of tailgating by analyzing the environment image data using the computer vision system. For example, in some implementations, the computer vision system may identify and track a position of a target vehicle that is ahead and in the same lane as the ego vehicle (e.g., by leveraging object detection and/or lane detection algorithms). In some implementations, the computer vision system estimates the distance to the target vehicle using monocular or stereo vision techniques, LiDAR, and/or radar data, and correlates this distance with the current speed of the ego vehicle to calculate the time-to-collision or following time gap. If the computed following distance falls below a predefined safety threshold (e.g., less than two seconds at a given speed) or falls below the threshold for a predefined period of time, in some implementations, the method 200 records a tailgating event. In some implementations, the method 200 may further consider contextual factors such as ego vehicle class/weight, weather, traffic density, road conditions, and/or the like when determining the appropriate threshold. In some implementations, the method 200 may also capture and associate the tailgating event with supporting image/video evidence and/or relevant context such as the time, location, and/or duration of the tailgating event. In some implementations, the method 200 infers safe following behavior based on the absence of tailgating events or by detecting that the following distance consistently exceeds the safety threshold.

As another example, in some implementations, the method 200 may detect stop sign violations by analyzing the environment image data using the computer vision system. For example, in some implementations, the computer vision system is trained to recognize stop signs and their locations within the vehicle’s field of view (e.g., using object detection and traffic sign recognition models). In some implementations, the computer vision system monitors the vehicle’s approach to a detected stop sign and analyzes the vehicle’s speed profile (e.g., as reported by the vehicle telematics data or inferred from the environment image data) to determine whether the vehicle comes to a complete stop at the designated stop line or intersection. If the vehicle fails to stop or only slows down without fully stopping, in some implementations, the method 200 records a stop sign violation event, optionally recording and associating the event with supporting image/video evidence and/or relevant context such as the time and/or location of the stop sign violation. In some implementations, the method 200 infers safe stop sign compliance behavior based on the detection of complete stops at stop signs or the absence of violation events.

In step 206, the method 200 may determine one or more derived metrics (which may also be referred to as safety metrics) based on the detected safe and/or unsafe driving behaviors.

In some implementations, the derived metrics can include, but are not limited to, a driver safety score, historical performance, driver rankings, peer benchmarks, performance trends, performance volatility, and/or the like. In some implementations, the method 200 may determine the derived metrics using a deterministic numerical processing module (e.g., derived metrics module 120). This may prevent AI hallucination by ensuring that mathematical computations are performed by deterministic code (e.g., applying polynomial regression to classify performance trends, using standard deviation to assess performance volatility, and the like) instead of, in some implementations, an LLM.

In some implementations, the method 200 determines a driver safety score by aggregating and analyzing the detected safe/unsafe driving behaviors or events over a defined period. For example, in some implementations, the method 200 calculates a new driver safety score for a respective driver each week, month, or the like. In some implementations, the method 200 assigns values to various types of behaviors to determine the driver safety score. As a non-limiting example, in some implementations, the method 200 may assign values such as -6 for speeding events, -3 for hard braking/acceleration/corning events, -7 for tailgating events, -2 for seatbelt violation events, -7 for distracted driving events, +2 for compliance with speed limits or maintaining safe following distances, and/or the like. In some implementations, the driver safety score is represented as a numerical value within a defined range (e.g., 1-100), that reflects the driver’s overall safety performance during the evaluation period. In some implementations, a driver’s safety score may start at the maximum value (e.g., 100) and may be adjusted accordingly each time the driver’s safety score is recalculated based on new data.

In some implementations, the method 200 assigns weights to various types of behaviors—such as speeding, hard braking/acceleration/corning, tailgating, seatbelt violations, distracted driving, and positive actions like consistent compliance with speed limits or maintaining safe following distances—based on their relative impact on overall driving safety. In some implementations, the total weight of a particular unsafe event may be based on the severity of the event, such as the magnitude of excess speed over a speed limit, the delta between lateral/longitudinal acceleration values and a baseline/threshold, the duration of a seat belt violation, and the like. In some implementations, weighted events are combined using a scoring algorithm, which, in some implementations, may incorporate normalization and/or statistical modeling to account for differences in metric types, driving conditions, vehicle types, and/or the like. In some implementations, the resulting driver safety score is a quantitative measure represented as a numerical value within a defined range (e.g., 1-10, 1-100, or the like), that reflects the driver’s overall safety performance during the evaluation period.

In some implementations, the method 200 determines historical performance by maintaining a longitudinal record of the driver’s safety scores and/or event history over time. For example, in some implementations, the method 200 stores (e.g., via cloud server 130) past safety scores, event counts, and/or other relevant metrics for respective drivers, enabling the construction of a time series that captures changes in driving behavior and safety outcomes. In some implementations, this historical performance data allows for retrospective analysis, identification of long-term behavioral patterns, and assessment of the effectiveness of prior recommendations or coaching.

In some implementations, the method 200 determines driver rankings by comparing the safety scores of individual drivers within a defined cohort, such as a fleet, geographic region, peer group, or the like. For example, in some implementations, the method 200 sorts drivers based on their current and/or recent safety scores, assigning rank positions that reflect relative safety performance. In some implementations, rankings may be updated periodically and can be used to identify top-performing drivers, those in need of improvement, or to support incentive and recognition programs, for example.

In some implementations, the method 200 determines peer benchmarks by aggregating safety scores and/or event metrics across a relevant population of drivers, such as those operating similar vehicles, driving in comparable environments, belonging to the same organization, or the like. In some implementations, the method 200 computes statistical measures—such as mean, median, and percentile distributions—of safety scores and/or event frequencies within the peer group. These benchmarks may provide context for interpreting an individual driver’s performance, highlighting whether the driver is performing above, at, or below the normative standard for their cohort, for example.

In some implementations, the method 200 determines performance trends by analyzing the trajectory of a driver’s safety score and/or event metrics over successive evaluation periods. For example, in some implementations, the method 200 may apply statistical techniques such as polynomial regression or moving averages to the time series of safety scores and/or event metrics, classifying the trend as improving, worsening, or stable. This analysis enables early identification of positive or negative shifts in behavior, supporting timely correction or reinforcement, for example.

In some implementations, the method 200 determines performance volatility by measuring the variability or consistency of a driver’s safety score and/or event metrics over time. For example, in some implementations, the method 200 calculates statistical indicators such as standard deviation or coefficient of variation for the driver’s historical safety scores and/or event counts. High volatility may indicate inconsistent driving behavior or fluctuating risk exposure, while low volatility suggests stable and predictable performance. This information can be used to tailor feedback, prioritize coaching resources, or inform risk management strategies, for example.

In step 208, the method 200 may generate structured input data for an AI model (e.g., script generation module 122).

In some implementations, the AI model may comprise an LLM. In some implementations, the structured input data, or prompt, is designed to ensure that the AI model receives only high-quality, contextually relevant, and factually accurate information, thereby supporting the generation of a reliable script for driver feedback and coaching. For example, as discussed herein, in some implementations, rather than providing the AI model with raw numerical data or unprocessed video, the method 200 may employ deterministic algorithms and domain-specific modules (e.g., the vehicle telematics module 116, the computer vision module 118, and the derived metrics module 120) to extract, classify, and summarize key behavioral events and insights from the vehicle telematics data, the driver image data, the environment image data, historical data, and/or the like.

For example, as discussed herein, in some implementations, all (or at least some) mathematical computations—such as the calculation of driver safety score trends, standard deviations, performance trends or volatility, and the like—are performed outside the AI model / LLM. In some implementations, the results of these computations are converted into clear, pre-calculated linguistic statements, such as “the driver’s performance trend is worsening,” “the driver’s safety score is 85,” “the driver received 3 seatbelt violations last week,” “the driver’s safety score has improved for three consecutive weeks,” “the driver is ranked 3^{rd} on a peer driver safety leaderboard,” or the like. This approach ensures that the AI model / LLM works with reliable, factually grounded information and mitigates the risk of hallucination or misinterpretation of quantitative data.

In addition or alternatively, in some implementations, the computer vision system (e.g., computer vision module 118) provides structured classifications and/or quantitative metrics instead of inputting raw video data into the AI model / LLM. For example, in some implementations, the computer vision system may output a list of detected unsafe behaviors (e.g., “cell phone usage detected at 2:14 PM on Main St.”), positive actions (e.g., “safe following distance maintained for 95% of miles driven”), supporting quantitative metrics (e.g., “average following distance: 2.3 seconds”), and/or the like. In some implementations, the method 200 includes these structured outputs in the prompt to the AI model, thereby providing the AI model with actionable insights derived from specialized models, while avoiding the ambiguity and computational burden of interpreting raw visual data.

In some implementations, to further enhance the relevance and personalization of the feedback included in the generated script, the method 200 can incorporate textual notes from manually conducted coaching sessions and/or other historical coaching data into the structed input data / prompt. In some implementations, these notes may provide historical context, capturing prior interventions/recommendations, driver responses, and/or any qualitative observations made by human safety managers, for example. In some implementations, by including this information, the AI model is able to reference past coaching, avoid redundant advice, and build upon previous interactions in a manner that supports continuity and driver engagement.

In some implementations, the prompt includes a list of approved actionable guidance recommendations that the AI model is permitted to make to the driver and/or a list of nonapproved recommendations that must not be included in the script. As an example, an approved recommendation / prevention technique to address a driver’s speeding may be to suggest to the driver to utilize cruise control or to set an audible speed warning, while a nonapproved recommendation to address the driver’s speeding may be a suggestion to turn off the vehicle or walk instead of drive. This explicit guidance can enforce compliance with organizational policies, regulatory requirements, or best practices, and ensures that the generated script remains within defined boundaries.

In some implementations, the prompt includes instructions to organize the script according to a defined, multi-scene structure (e.g., that mirrors a pedagogical flow). In some implementations, each data element is labeled and/or grouped by category, such as “Introduction,” “Score Review,” “Positive Behaviors,” “Unsafe Behaviors Analysis,” “Improvement Areas,” “Performance Trend,” “Actionable Guidance,” “Summary,” “Key Takeaways,” “Conclusion,” and/or the like. This structure ensures that the AI model’s output will be logically organized and easily parsed for downstream video synthesis, for example.

In some implementations, each detected event—such as a speeding event, hard braking event, or a stop sign violation event—is associated with metadata that may include the event type, timestamp, location, a unique identifier or file path for the corresponding video or image, and/or the like. In some implementations, at least a portion of this metadata is incorporated into the structured input data provided to the AI model, enabling the AI model to generate a script that contains clear indications of when and which supporting media should be presented. For example, this may enable a video or image of a specific safe/unsafe behavior / event to be displayed concurrently with an avatar’s narration of the event. As an example, in some implementations, placeholders or embedded tags may be used to denote the points at which specific video or image assets should be displayed. For example, the script may include a directive such as “[Display dashcam video: event_id_12345]” or “[Show map image: speeding_event_67890]” at the appropriate juncture in the narrative. In some implementations, as discussed further below, these references serve as programmatic cues for the downstream video engine 126, which parses the script and retrieves the designated media assets from storage or a media repository (e.g., cloud server 130).

In some implementations, the prompt includes instructions directing the AI model to perform an internal planning phase or thought process step before generating the final script. For example, in some implementations, the AI model is instructed to review the structured input data, identify key coaching points, and outline the narrative strategy. By embedding these instructions, in some implementations, the method 200 ensures that the AI model’s output is not only factually accurate and contextually rich, but also logically coherent and pedagogically effective.

In some implementations, the prompt includes detailed guidance to the AI model regarding the tone, persona consistency, naturalness, linguistic style, and/or the like of the generated script. For example, in some implementations, the prompt can instruct the AI model to produce a natural-sounding narrative that resembles conversational human speech, thereby enhancing driver engagement and comprehension. This may involve directives to incorporate natural pauses—such as brief hesitations or breaks between key points by incorporating commas, ellipses, or the like into the script—to mirror the pacing of effective verbal communication. In addition or alternatively, in some implementations, the prompt can specify that certain technical terms or acronyms, such as “mph,” should be spelled out as “miles per hour,” ensuring that the script sounds like natural speech and is accessible to a broad audience regardless of familiarity with industry jargon. In some implementations, these stylistic instructions are embedded within the prompt alongside the structured data, enabling the AI model to generate a script that is not only factually accurate and pedagogically sound, but also approachable, clear, and well-suited for delivery through an avatar or voice synthesis system, for example.

In step 210, the method 200 may execute the AI model to generate the script.

For example, in some implementations, the method 200 may provide the structured input data generated in the previous steps as input to the AI model and may execute the AI model. Based on the structured input data, the AI model may generate a comprehensive, multi-scene narrative tailored to the individual driver’s recent behaviors and performance, for example. As discussed above, in some implementations, the execution of the AI model and generation of the script is governed by explicit instructions embedded within the structured input data / prompt. For example, in some implementations, following the planning phase, the AI model proceeds to generate the actual script, adhering to a defined, multi-scene structure as specified in the prompt. In some implementations, each scene is crafted to fulfill a distinct narrative function, such as providing an empathetic introduction, reviewing the driver’s safety score and performance trends, acknowledging positive behaviors, analyzing unsafe events, and delivering actionable guidance.

In step 212, the method 200 may perform one or more QA checks on the generated script.

In some implementations, the one or more QA checks may serve to validate the script across multiple dimensions such as factuality, relevancy, naturalness, tonality, and/or the like. In some implementations, some or all of the QA checks are performed by specifically prompted AI judges, such as LLMs.

For example, in some implementations, factuality verification is performed by prompting an AI judge to extract all numerical claims and factual assertions from the generated script, including safety scores, performance trends, event details, and the like. In some implementations, these extracted claims are then programmatically compared against the ground-truth source data that was used to generate the structured input.

In some implementations, in addition to factuality, the method 200 may employ additional AI judges, each prompted with specific evaluation rubrics (e.g., for assessing relevancy, conversational flow, persona consistency, empathetic tone, and/or the like) to assess the remaining dimensions. As an example, for relevancy, in some implementations, the AI judge is instructed to determine whether the script content is directly pertinent to the driver’s recent behaviors, performance metrics, coaching objectives, and/or the like, ensuring that extraneous or generic information is excluded, for example. As another example, for naturalness, in some implementations, the AI judge is instructed to evaluate the conversational flow, linguistic clarity, the degree to which the script resembles authentic human communication, and/or the like, including the use of natural pauses and accessible language. As yet another example, for tonality, in some implementations, the AI judge assesses persona consistency, empathetic tone, alignment with the organization’s communication standards, and/or the like, ensuring that the script is supportive, motivational, and follows relevant standards.

In some implementations, for each quality dimension—such as factuality, relevancy, naturalness, and tonality—the method 200 determines a quantitative or qualitative score by prompting the corresponding AI judge with a specific evaluation rubric tailored to that dimension. For example, the AI judge may systematically review the generated script and assign a score based on the degree to which the script satisfies the defined criteria in the rubric.

In some implementations, to maintain the integrity and reliability of the QA process, the performance of the AI judges is continuously benchmarked and calibrated against a manually curated and annotated “Golden Set” of coaching scripts. This Golden Set may serve as a reference standard, ensuring that the automated evaluations remain aligned with human expert judgment, for example.

In step 214, the method 200 evaluates whether the script passes all the QA checks.

For example, in some implementations, the method 200 may evaluate whether each script passes all the QA checks by comparing the determined score for each QA dimension to a predefined threshold established for that dimension.

If the script does not pass all the QA checks, the method 200 proceeds to step 216, where it generates structured feedback based on the failed QA checks. For example, in some implementations, the generate structured feedback may detail the inaccuracies or deficiencies identified by the AI judges. As an example, in some implementations, any discrepancies, omissions, hallucinated claims or values, or errors in other dimensions are flagged, and the script is annotated with precise feedback regarding the nature and location of the issues. In some implementations, the feedback may be generated separately from the script (e.g., as a separate file or prompt) and associated with the script. From step 216, the method 200 loops back to step 210 to execute the AI model to regenerate the script based on the structured feedback. In some implementations, this closed-loop verification and correction cycle continues until the script achieves satisfactory scores across all QA dimensions, thereby ensuring a high-quality, reliable, and effective script for video generation.

If the script passes all the QA checks, the script is validated and the method 200 proceeds to step 218, where it outputs the validated script.

In some implementations, the method 200 may store the validated script in a database (e.g., cloud server 130) and/or may store the QA scores and/or any other associated data, feedback, prior script versions, or the like. In some embodiments, the feedback, prior script versions, and/or other data may be used to refine prompting strategies and/or the QA models. for example.

After step 218 the method 200 may terminate. However, as discussed herein, in some implementations, the method 200 may continue to run periodically (e.g., every week) to generate new scripts based on new safety scores and/or other data associated with the driver.

FIG. 3 is a flow diagram illustrating a method for automatically generating a pedagogically structured, multi-scene video based on a validated script, according to some of the disclosed embodiments. In some implementations, method 300 may be performed by the video engine 126 of FIG. 1.

Referring to FIG. 3, in step 302, the method 300 includes receiving a validated script.

In some implementations, the received script is the output of the preceding multi-stage script generation and QA process, as described in connection with method 200, for example. In some implementations, receiving the validated script comprises the method 300 obtaining the validated script from a database (e.g., cloud server 130).

In step 304, the method 300 parses the script into scenes.

In some implementations, upon receiving the validated script, the method 300 initiates a parsing process that analyzes the script’s structure and content to delineate discrete narrative segments, or scenes, in accordance with the predefined multi-scene format established during script generation. In some implementations, each scene is identified based on structural markers, embedded tags, categorical labels, or the like within the script, such as “Introduction,” “Safety Score Review,” “Positive Behaviors,” “Unsafe Behaviors Analysis,” “Actionable Guidance,” “Conclusion,” and/or the like. In some implementations, this parsing process ensures that each segment of the narrative is logically separated and can be individually processed, rendered, and/or synchronized with corresponding audio and/or visual assets, for example.

During parsing, in some implementations, the method 300 extracts the textual content, associated metadata, and/or any embedded references to supporting media for each scene. As an example, in some implementations, a scene discussing a specific unsafe event may include a directive to display a particular dashcam video or map image, relevant event identifiers, timestamps, and/or the like. In some implementations, the method 300 records these associations, creating a structured representation of the script in which each scene is mapped to its required visual, audio, and/or contextual elements. This structured representation can facilitate downstream processing, enabling the method 300 to assemble the final video in a modular and programmatically controlled manner.

In step 306, the method 300 generates or selects an avatar.

In some implementations, the method 300 determines the appropriate digital avatar to serve as the visual and/or narrative guide throughout the video. In some implementations, the avatar may be selected from a library of pre-existing personas (which, e.g., can be stored on cloud server 130), which can include generic characters or customized “digital twin” avatars modeled to visually and/or vocally replicate a specific company’s safety manager or another trusted coaching persona. In some implementations, the avatar selection process may be governed by organizational preferences, driver profile attributes, or contextual requirements specified in the script or associated metadata, for example.

In some implementations, if a custom avatar is required and not already available, the method 300 initiates an avatar generation process. For example, in some implementations, this process may involve synthesizing the avatar’s visual likeness using advanced computer graphics techniques, capturing facial features, gestures, expressions, and/or the like to ensure a high-fidelity and relatable representation. In some implementations, the avatar’s voice may be generated using text-to-speech technology, with options for voice customization to match the desired tone, accent, and persona. In some implementations, the customized avatar or avatar model can be generated based on one or more pictures, videos, or audio clips of the target coaching persona. In some implementations, a human-in-the-loop quality assurance step is performed to review and approve the avatar’s appearance and vocal characteristics, ensuring that the digital representation is both accurate and appropriate for the intended audience.

In some implementations, once the avatar is generated or selected, it is configured to deliver the script’s narrative content in a manner that is engaging, empathetic, and/or consistent with the organization’s communication standards. For example, in some implementations, the avatar’s parameters—such as visual style, voice settings, and behavioral cues—are programmatically linked to the parsed scenes, enabling seamless integration with the video synthesis pipeline. In some implementations, this step ensures that the avatar will effectively guide the driver through each segment of the feedback video, enhancing trust, comprehension, and overall engagement with the coaching content.

In step 308, the method 300 generates or selects one or more pre-rendered assets.

In some implementations, pre-rendered assets may include standardized video segments, such as introductions, conclusions, or other recurring narrative elements, as well as visual components such as branded backgrounds, data visualization templates, or animated transitions. In some embodiments, these assets are created in advance and stored in an asset library (e.g., cloud server 130), allowing for efficient reuse across multiple videos and ensuring consistency in visual quality and messaging, for example. In some implementations, if pre-rendered assets are not available, such as when the method 300 generates a new avatar, the method 300 may generate a defined collection of pre-rendered assets such that if a new script is generated and that avatar is selected, pre-rendered assets—such as introductions—will be available, thereby reducing cost and processing power required for that video.

In some implementations, the selection of appropriate pre-rendered assets is guided by the structure and content of the parsed script. As an example, if the script includes a standard introduction or closing message, in some implementations, the method 300 retrieves the corresponding pre-rendered video segment featuring the selected avatar delivering those lines. As another example, if the script calls for the display of safety score trends, leaderboard rankings, or other data-driven visualizations, in some implementations, the method 300 selects the relevant graphical templates or animation sequences from the asset library. In some implementations, the method 300 may dynamically customize certain pre-rendered assets by overlaying driver-specific information, such as names, scores, or event details, to enhance personalization while maintaining production efficiency.

In some implementations, by integrating pre-rendered assets into the video generation workflow, the method 300 is able to balance scalability and quality, leveraging high-fidelity content for standardized scenes while reserving dynamic synthesis for personalized or event-specific segments. This approach streamlines the video assembly process, reduces computational overhead, and ensures that each driver feedback video adheres to established visual and narrative standards, for example.

In step 310, the method 300 generates one or more dynamic scenes.

In some implementations, dynamic scenes are generated in response to specific events or data points identified in the script, such as unsafe driving events, positive behavioral milestones, personalized coaching recommendations, or the like. In some implementations, these scenes are constructed using a combination of real-time data, event-specific media assets, and/or synthesized avatar narration and/or animation. For example, in some implementations, for each dynamic scene, the method 300 retrieves relevant supporting media, such as dashcam video footage, map images illustrating speeding or other event locations, or data visualizations (e.g., as referenced by embedded tags or placeholders within the script or representation of the script). In some implementations, the avatar’s narration for each scene is generated using text-to-speech models, ensuring that the spoken content aligns with the script and is synchronized with the display of visual media. In some implementations, the method 300 may also animate the avatar’s facial expressions, gestures, and body language to enhance engagement and reinforce the narrative, for example.

In some implementations, the generation of dynamic scenes involves the programmatic assembly of multiple media elements, including overlaying driver-specific data, highlighting key events, and sequencing video clips to correspond with the timing of the avatar’s narration. In some implementations, the method 300 ensures that each dynamic scene is contextually rich, visually coherent, and pedagogically effective, providing the driver with clear, actionable feedback supported by direct visual confirmation of the events being discussed.

In step 312, the method 300 assembles all scenes into a driver feedback or coaching video.

After the individual scenes—comprising both pre-rendered and dynamically generated segments—have been created, in some implementations, the method 300 initiates an assembly process to construct a cohesive, multi-scene video tailored to the driver’s unique behavioral profile and coaching needs. In some implementations, this process involves sequencing the scenes in accordance with the structured narrative flow defined in the validated script, ensuring that each segment transitions smoothly and logically to the next.

In some implementations, during assembly, the method 300 synchronizes the avatar’s narration, visual media assets, and any supporting data visualizations to maintain narrative coherence and maximize pedagogical impact. In some implementations, the method 300 may also apply standardized branding elements, animated transitions, captions, and/or the like to enhance the overall production quality and ensure consistency with organizational standards, for example.

In some implementations, the assembly process includes a final quality assurance review, verifying that all scenes are present, correctly ordered, and free of technical errors such as misaligned audio, missing media, or visual artifacts, for example. In some implementations, the completed video is encoded in a desired format, optimized for delivery through the intended channels, such as mobile applications, web portals, or direct messaging platforms.

In step 314, the method 300 transmits the video.

In some implementations, the method 300 determines an appropriate transmission channel based on organizational preferences, driver accessibility, and/or workflow requirements. As an example, in some implementations, transmission channels may include direct push notifications to a driver’s mobile application, secure links delivered via SMS or email, integration with fleet management platforms, assignment within a task management system, and/or the like.

In some implementations, metadata associated with the video—such as driver identifiers, event timestamps, and delivery status—is appended to facilitate tracking, auditability, and downstream analytics. In some implementations, the method 300 may also log the transmission event, recording details such as the time of delivery, recipient information, and any relevant workflow or notification metadata. In some implementations, the method 300 may implement delivery confirmation mechanisms, such as read receipts or playback analytics, to monitor driver engagement and inform subsequent coaching interventions, for example. By transmitting the video through secure and accessible channels, in some implementations, the method 300 completes the end-to-end feedback loop, supporting continuous improvement in driver safety and performance.

After step 314 the method 300 may terminate. However, as discussed herein, in some implementations, the method 300 may continue to run periodically (e.g., every week) to generate new videos based on new scripts, for example.

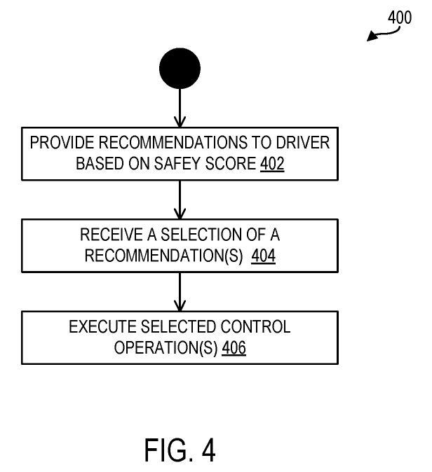

FIG. 4 is a flow diagram illustrating a method for performing a control operation to implement a coaching recommendation, according to some of the disclosed embodiments.

Referring to FIG. 4, in step 402, the method 400 includes providing recommendations to a driver based on a safety score and/or other metrics of the driver.

As discussed above (e.g., in connection with method 200 and method 300), in some implementations, recommendations / prevention techniques may be provided to a driver based on the driver’s safety score and/or recent unsafe driving behaviors / events. As an example, in some implementations, the video generated in method 300 may include a recommendation for a driver who has one or more speeding violations to utilize cruise control, enable an audible speed warning, adjust (e.g., reduce or soften) a throttle response of the vehicle, or the like. As another example, for a driver who has exhibited hard braking events, the system may recommend maintaining a greater following distance, anticipating traffic flow, or practicing smoother deceleration techniques. In the case of hard acceleration incidents, the feedback may suggest gradual throttle application, avoiding rapid starts, adjusting (e.g., reducing or softening) a throttle response of the vehicle, or utilizing eco-driving modes. For hard cornering events, the system may advise reducing speed before entering turns, steering smoothly, and being mindful of road conditions. If tailgating is detected, the video may recommend using adaptive cruise control, monitoring time gaps to the vehicle ahead, or following a three-second rule for safe spacing. For seatbelt violations, the system may remind the driver to always fasten the seatbelt before driving and to check for proper fit. In instances of distraction or phone/device usage, the feedback may include recommendations to stow electronic devices, use hands-free systems only when necessary, and remain focused on the road at all times. For stop sign violations, the system may advise approaching intersections with caution, coming to a complete stop, and scanning for cross traffic before proceeding. These recommendations are merely examples and a greater or fewer number of recommendations may be provided.

In some implementations, some recommendations can be implemented by the method 400 automatically by executing a control operation. For example, in some implementations, certain recommendations such as reducing a throttle response, changing a drive mode (e.g., from sport or normal to eco) of the vehicle, activating cruise control, setting an audible or haptic based speed warning, setting an autonomous following distance, and/or the like can be implemented by the method 400 by executing a corresponding control operation. In some implementations, the method 400 may provide an option for the driver to select a recommendation to be automatically implemented. For example, in some implementations, the video and/or application, web portal, or the like that the video is playing within, can provide the driver the option (e.g., in the form of a UI button or the like).

In step 404, the method 400 receives a selection of one or more recommendations.

In some implementations, upon the user selecting one or more of the recommendations, the method 400 may receive the selection. For example, the device that the user is using to view the video (e.g., a mobile phone, a tablet, a laptop, a computer, and/or any other device that is communicatively coupled to the vehicle and/or the vehicle gateway 104) can transmit the selection to the cloud server 130 and/or to the vehicle gateway 104.

In step 406, the method 400 executes the selected control operation.

In some implementations, as discussed herein, executing the control operation may comprise the method 400 sending control signals or commands to appropriate vehicle systems or actuators, such as the actuator 112, to implement the selected control operation. For example, in some implementations, the method 400 may transmit these commands via the cloud server 130 and/or vehicle gateway 104 to the relevant ECUs within the vehicle, ensuring that the control operation is carried out in accordance with the driver’s selection.

As an example, in some implementations, if the selected recommendation involves reducing the throttle response, the method 400 may adjust a throttle mapping of the vehicle. If the driver has chosen to activate cruise control, the method 400 may send a command to the vehicle’s cruise control module to engage the feature and set the desired speed threshold. In the case of enabling an audible or haptic speed warning, the method 400 may interface with the vehicle’s audio or haptic feedback systems to generate alerts when the vehicle exceeds a predefined speed limit.

FIG. 5 is a flow diagram illustrating a method for automatically updating and refining script and video generation models according to some of the disclosed embodiments. In some implementations, method 500 may be performed by the update module 132 of FIG. 1.

Referring to FIG. 5, in step 502, the method 500 includes determining coaching effectiveness.

In some implementations, this step involves the method 500 evaluating the impact of delivered coaching interventions on driver behavior and safety outcomes over time. For example, in some implementations, the method 500 collects and analyzes a range of data points, including post-coaching safety scores, task completion rates (e.g., such as tasks to watch training videos), and/or subsequent changes in the occurrence of unsafe or positive driving behaviors. By comparing these metrics before and after the delivery of coaching videos and/or implementation of recommendations or control operations, in some implementations, the method 500 is able to assess whether the coaching has resulted in measurable improvements in driver performance, reductions in risk-related events, increased adherence to safety protocols, or the like.

In step 504, the method 500 identifies correlations between coaching characteristics and coaching effectiveness.

In step 504, the method 500 identifies correlations between coaching characteristics and coaching effectiveness. Following the determination of coaching outcomes, the system undertakes a detailed analysis to uncover relationships between specific attributes of the coaching interventions and the observed changes in driver behavior and safety performance. This process involves aggregating and examining data across multiple coaching sessions, drivers, and time periods to discern which coaching characteristics—such as script structure, tone, delivery channel, timing, or the inclusion of certain recommendations—are most strongly associated with positive behavioral change or risk reduction.

In some implementations, the method 500 may employ statistical techniques, such as correlation analysis, regression modeling, or machine learning algorithms, to evaluate the influence of various coaching characteristics on key effectiveness metrics. As an example, the analysis might reveal that coaching sessions with a highly empathetic tone or those that include personalized, actionable guidance are more likely to result in sustained improvements in safety scores or reductions in specific unsafe behaviors. As another example, the method 500 might identify that certain delivery methods, such as video-based feedback with synchronized event footage, are more effective in engaging drivers and promoting task completion.

In step 506, the method 500 updates prompting strategy and QA checks based on the identified correlations.

Drawing upon the insights gained from the analysis of coaching outcomes and their associated attributes, in some implementations, the method 500 systematically refines the design and delivery of future coaching videos. In some implementations, this may involve modifying the structure, tone, or content of the prompts provided to the script generating AI model, as well as adjusting the evaluation rubrics and thresholds used in the multi-dimensional QA framework, for example.

As an example, if the analysis reveals that scripts with a more empathetic tone or those that include highly personalized, actionable recommendations are correlated with greater improvements in driver safety scores, the method 500 might update the prompting strategy to emphasize these elements in subsequent script generation. As another example, if certain delivery channels or narrative structures are found to be more effective in engaging drivers, the method 500 might prioritize their use in future feedback sessions. In some implementations, the QA checks are recalibrated to ensure that the evaluation criteria remain aligned with the most impactful coaching practices, thereby maintaining high standards for factuality, relevancy, naturalness, and tonality.

In some implementations, these updates are implemented in an iterative and data-driven manner, allowing the autonomous coaching pipeline to adapt dynamically to evolving organizational goals, regulatory requirements, and driver needs, for example.

FIG. 6 is a block diagram of a computing device according to some embodiments of the disclosure.

As illustrated, the device 600 includes a processor or central processing unit (CPU) such as CPU 602 in communication with a memory 604 via a bus 614. The device also includes one or more input/output (I/O) or peripheral devices 612. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 602 may comprise a general-purpose CPU. The CPU 602 may comprise a single-core or multiple-core CPU. The CPU 602 may comprise a system-on-a-chip (SoC) or a similar embedded system. In some embodiments, a graphics processing unit (GPU) may be used in place of, or in combination with, a CPU 602. Memory 604 may comprise a memory system including a dynamic random-access memory (DRAM), static random-access memory (SRAM), Flash (e.g., NAND Flash), or combinations thereof. In one embodiment, the bus 614 may comprise a Peripheral Component Interconnect Express (PCIe) bus. In some embodiments, the bus 614 may comprise multiple busses instead of a single bus.

Memory 604 illustrates an example of a non-transitory computer storage media for the storage of information such as computer-readable instructions, data structures, program modules, or other data. Memory 604 can store a basic input/output system (BIOS) in read-only memory (ROM), such as ROM 608 for controlling the low-level operation of the device. The memory can also store an operating system in random-access memory (RAM) for controlling the operation of the device.

Applications 610 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 606 by CPU 602. CPU 602 may then read the software or data from RAM 606, process them, and store them in RAM 606 again.

The device may optionally communicate with a base station (not shown) or directly with another computing device. One or more network interfaces in peripheral devices 612 are sometimes referred to as a transceiver, transceiving device, or network interface card (NIC).

An audio interface in peripheral devices 612 produces and receives audio signals such as the sound of a human voice. For example, an audio interface may be coupled to a speaker and microphone (not shown) to enable telecommunication with others or generate an audio acknowledgment for some action. Displays in peripheral devices 612 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 612 may comprise any input device arranged to receive input from a user. An illuminator in peripheral devices 612 may provide a status indication or provide light. The device can also comprise an input/output interface in peripheral devices 612 for communication with external devices, using communication technologies, such as USB, infrared, Bluetooth®, or the like. A haptic interface in peripheral devices 612 provides tactile feedback to a user of the client device.

A GPS receiver in peripheral devices 612 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

We claim:

1. A system comprising:
a vehicle gateway device configured to receive, from at least one sensor associated with a vehicle, driver behavior data and configured to transmit the driver behavior data; and
a remote computing system including a processor and a memory storing instructions that, when executed by the processor, cause the processor to:
receive, from the vehicle gateway device, the driver behavior data;
analyze the driver behavior data to identify a safety-related event;
determine a safety metric based on the identified safety-related event;
generate, via a first artificial intelligence model, a feedback script based on the identified safety-related event and the determined safety metric;
perform, via a second artificial intelligence model, a quality assurance check on the feedback script to identify a deficiency;
update, via the first artificial intelligence model, the feedback script based on the identified deficiency;
generate a feedback video based on the updated feedback script; and
transmit the feedback video to a device associated with a driver of the vehicle.

2. The system of claim 1, wherein the instructions further cause the processor to:
determine an updated safety metric based on new driver behavior data that is received subsequent to transmitting the feedback video;
determine an effectiveness of the feedback video based on the updated safety metric;
determine a correlation between a characteristic of the feedback video and the updated safety metric; and
update at least one of a prompting strategy for the first artificial intelligence model or a quality assurance rubric for the second artificial intelligence model based on the determined correlation.

3. The system of claim 1, wherein the safety metric is determined using deterministic processing.

4. The system of claim 3, wherein the safety metric comprises at least one of a driver safety score, a performance trend, a performance volatility, or historical performance.

5. The system of claim 1, wherein the driver behavior data comprises at least one of vehicle telematics data associated with the vehicle, driver image data associated with the driver, or environment image data associated with an environment of the vehicle.

6. The system of claim 5, wherein the safety-related event comprises at least one of a seatbelt violation event, a braking event, an acceleration event, a corning event, a tailgating event, a device usage event, or a distracted driving event.

7. The system of claim 1, wherein the first artificial intelligence model comprises a large language model (LLM).

8. A method comprising:
receiving, by a processor, driver behavior data from a vehicle gateway device associated with a vehicle;
analyzing, by the processor, the driver behavior data to identify a safety-related event;
determining, by the processor, a safety metric based on the identified safety-related event;
generating, by the processor and via a first artificial intelligence model, a feedback script based on the identified safety-related event and the determined safety metric;
performing, by the processor and via a second artificial intelligence model, a quality assurance check on the feedback script to identify a deficiency;
updating, by the processor and via the first artificial intelligence model, the feedback script based on the identified deficiency;
generating, by the processor, a feedback video based on the updated feedback script; and
transmitting the feedback video to a device associated with a driver of the vehicle.

9. The method of claim 8, further comprising:
determining, by the processor, an updated safety metric based on new driver behavior data that is received subsequent to transmitting the feedback video;
determining, by the processor, an effectiveness of the feedback video based on the updated safety metric;
determining, by the processor, a correlation between a characteristic of the feedback video and the updated safety metric; and
updating, by the processor, at least one of a prompting strategy for the first artificial intelligence model or a quality assurance rubric for the second artificial intelligence model based on the determined correlation.

10. The method of claim 8, wherein the safety metric is determined using deterministic processing.

11. The method of claim 10, wherein the safety metric comprises at least one of a driver safety score, a performance trend, a performance volatility, or historical performance.

12. The method of claim 8, wherein the driver behavior data comprises at least one of vehicle telematics data associated with the vehicle, driver image data associated with the driver, or environment image data associated with an environment of the vehicle.

13. The method of claim 12, wherein the safety-related event comprises at least one of a seatbelt violation event, a braking event, an acceleration event, a corning event, a tailgating event, a device usage event, or a distracted driving event.

14. The method of claim 8, wherein the first artificial intelligence model comprises a large language model (LLM).

15. A non-transitory computer-readable storage medium for tangibly storing computer program instructions capable of being executed by a computer processor, the computer program instructions defining steps of:
receiving driver behavior data from a vehicle gateway device associated with a vehicle;
analyzing the driver behavior data to identify a safety-related event;
determining a safety metric based on the identified safety-related event;
generating, via a first artificial intelligence model, a feedback script based on the identified safety-related event and the determined safety metric;
performing, via a second artificial intelligence model, a quality assurance check on the feedback script to identify a deficiency;
updating, via the first artificial intelligence model, the feedback script based on the identified deficiency;
generating a feedback video based on the updated feedback script; and
transmitting the feedback video to a device associated with a driver of the vehicle.

16. The non-transitory computer-readable storage medium of claim 15, wherein the computer program instructions further define steps of:
determining an updated safety metric based on new driver behavior data that is received subsequent to transmitting the feedback video;
determining an effectiveness of the feedback video based on the updated safety metric;
determining a correlation between a characteristic of the feedback video and the updated safety metric; and
updating at least one of a prompting strategy for the first artificial intelligence model or a quality assurance rubric for the second artificial intelligence model based on the determined correlation.

17. The non-transitory computer-readable storage medium of claim 15, wherein the safety metric is determined using deterministic processing.

18. The non-transitory computer-readable storage medium of claim 17, wherein the safety metric comprises at least one of a driver safety score, a performance trend, a performance volatility, or historical performance.

19. The non-transitory computer-readable storage medium of claim 15, wherein the driver behavior data comprises at least one of vehicle telematics data associated with the vehicle, driver image data associated with the driver, or environment image data associated with an environment of the vehicle.

20. The non-transitory computer-readable storage medium of claim 19, wherein the safety-related event comprises at least one of a seatbelt violation event, a braking event, an acceleration event, a corning event, a tailgating event, a device usage event, or a distracted driving event.
